(19) United States
(12) Patent Application Publication
(10) Pub. No.: US 2014/0087803 A1
(43) Pub. Date: Mar. 27, 2014

(54) DOUBLE DRAW POKER CASINO CARD GAME

(71) Applicant: SHFL entertainment, Inc., Las Vegas, NV (US)

(72) Inventor: Ronald LaDuca, Ledyard, CT (US)

(73) Assignee: SHFL entertainment, Inc., Las Vegas, NV (US)

(21) Appl. No.: 13/779,547

(22) Filed: Feb. 27, 2013

Related U.S. Application Data
(60) Provisional application No. 61/744,339, filed on Sep. 24, 2012.

(51) Int. Cl. G07F 17/32; A63F 1/00

(52) U.S. Cl. CPC G07F 17/3293; A63F 1/00
USPC 463/13; 273/292

(57) ABSTRACT

A method for playing a double draw poker casino card game. The method comprising providing a standard 52-card deck of playing cards for playing a standard draw poker casino card game. Providing two joker cards shuffled together with the standard 52 card deck. Each of the two joker cards valued as an ace or as a fill-in card for a straight, or as a fill-in card for a flush. Each player placing an ante and a bonus bet and receiving five dealt cards. Each player folding or making a first optional draw card bet and discarding and drawing up to three draw cards. Each player folding or making a second optional draw card bet and discarding and drawing up to one draw card producing a final double draw five card poker hand, each receiving a payout against a first payout table for the ante and draw bets and a second payout table for the bonus bet.

### CROSS-REFERENCE TO RELATED APPLICATIONS

The present utility patent application claims the benefit of applicant's provisional application No. 61/744,339 filed Sep. 24, 2012.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to a method for playing a double draw poker casino card game, the method comprising providing a standard 52-card deck of playing cards for playing a standard draw poker casino card game and further providing two joker cards shuffled together with the standard 52 card deck, each of the two joker cards valued as an ace or as a fill-in card for a straight, or as a fill-in card for a flush; each player placing an ante and a bonus bet and receiving five dealt cards, the player having a first optional draw card bet and discarding and drawing up to three draw cards, the player having a second optional draw card bet discarding and drawing up to one draw card producing a final double draw five card poker hand receiving a payout against a first payout table for the ante and draw bets and a second payout table for the bonus bet.

2. Description of Related Art Including Information Disclosed Under 37 CFR 1.97 and 1.98

Part of the excitement of poker card games is to be dealt a high scoring hand to win in a game of poker. Draw poker with a single draw of up to three cards further increases the chance of being dealt a high scoring hand and hence the enticement to play and to bet on a five card poker hand.

Playing poker against other players with unlimited betting and raising opportunities increases the excitement of playing poker, but does not increase the chance of winning a hand, which may sometimes last for many long rounds of betting and raising.

There is also an element of bluffing or using other tactics to win in a game of poker played against other players, so that the highest scoring poker hand does not always win.

It is desirable to increase a player's chances of winning and to provide quicker games to allow a player more chances to win in a given time period, and to provide a game wherein there is a certainty of winning a specific amount of money for each specific five card poker hand.

### BRIEF SUMMARY OF THE INVENTION

An object of the present invention is to provide a method of playing a double draw five card poker casino card game having a first optional draw up to three cards and a second optional draw up to one card to increase a player's chances of producing a high scoring five card poker hand by having two draws instead of one draw to improve a five card poker hand.

Another object of the present invention is to provide a method for playing a double draw five card casino poker game which is paid out against two specified payout tables with specific returns for specific five card poker hands for a fast and certain outcome for a player, thereby increasing the speed of the poker game and eliminating bluffing and other player strategies which occur when trying to beat poker hands held by other players, and providing the certainty of knowing what the payout will be for each five card poker hand.

In brief, a method for a double draw poker casino card game of the present invention comprises a player receiving five dealt cards and having a first optional draw; discarding and drawing up to three draw cards, and having a second optional draw; discarding and drawing up to one draw card; producing a final double draw five card poker hand receiving a payout against a first payout table for the ante and draw bets and a second payout table for the bonus bet.

The method of the present invention of playing a double draw poker casino card game comprises:

a) a first step of providing a standard 52-card deck of playing cards for playing a standard draw poker casino card game and further providing two joker cards shuffled together with the standard 52 card deck, each of the two joker cards valued as an ace or as a fill-in card for a straight, or as a fill-in card for a flush;

b) a second step of placing an ante bet in a first location in front of each player;

c) a third step of placing a mandatory bonus bet in a second location in front of each player;

d) a fourth step of dealing five cards face down to each player;

e) a fifth step of the player viewing the player's own five dealt cards;

f) a sixth step of exercising an option to fold the player's own five dealt cards and forfeiting the player's ante bet and bonus bet, thereby ending the folding player's game for the hand; or an alternate sixth step of exercising an alternate option of placing a first draw bet to discard and draw up to three cards in a third location in front of the player;

g) a seventh step of discarding and drawing from zero to three cards thereby holding a five card hand;

h) an eighth step of exercising an option to fold the player's own held five card hand and forfeiting the player's ante bet and bonus bet and first draw bet, thereby ending the folding player's game for the hand; or an alternate eighth step of exercising an alternate option of placing a second draw bet to discard and draw up to one card in a fourth location in front of the player;

i) a ninth step of discarding and drawing from zero to one card thereby holding a final five card hand;

j) a tenth step of paying out the final five card hand for each player according to a first payout table for the ante and draw bets and a second payout table for the bonus bet.

An advantage of the present invention is that it provides an opportunity to build higher scoring five card poker hands.

Another advantage of the present invention is that it provides a fast game of five card poker with definite specified payouts for different five card poker hands.

An added advantage of the present invention is that it provides three betting opportunities for a player.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a plan view showing a double draw poker casino card game playing table showing the player layouts and pay tables facing the players and the dealer layout and pay tables facing the dealer on the other side of the playing table from the players;

FIG. 2 is an exploded plan view showing a first embodiment of the double draw poker casino card game playing table payout tables facing the dealer (appearing upside-down to the players);

FIG. 3 is an exploded plan view showing a first embodiment of a player layout and payout tables of the double draw poker casino card game playing table facing a player;

FIG. 4 is an exploded plan view showing a second embodiment of the double draw poker casino card game playing table payout tables facing the dealer (appearing upside-down to the players);

FIG. 5 is an exploded plan view showing a second embodiment of a player layout and payout tables of the double draw poker casino card game playing table facing a player;

FIG. 6 is an elevational view of a simulation of the double draw poker casino card game playing table layout shown on a screen of an electronic simulation device showing a simulation of the player layouts and pay tables and the dealer layout and pay tables and five cards held by a player;

FIG. 7 is an elevational view of a simulation of the double draw poker casino card game playing table layout shown on a screen of a computer device showing a simulation of the player layouts and pay tables and the dealer layout and pay tables and five cards held by a player;

FIG. 8 is an elevational view of a simulation of a player layout for the double draw poker casino card game playing table layout shown on a screen of a wireless device showing a simulation of the player layouts and pay tables and five cards held by a player.

### DETAILED DESCRIPTION OF THE INVENTION

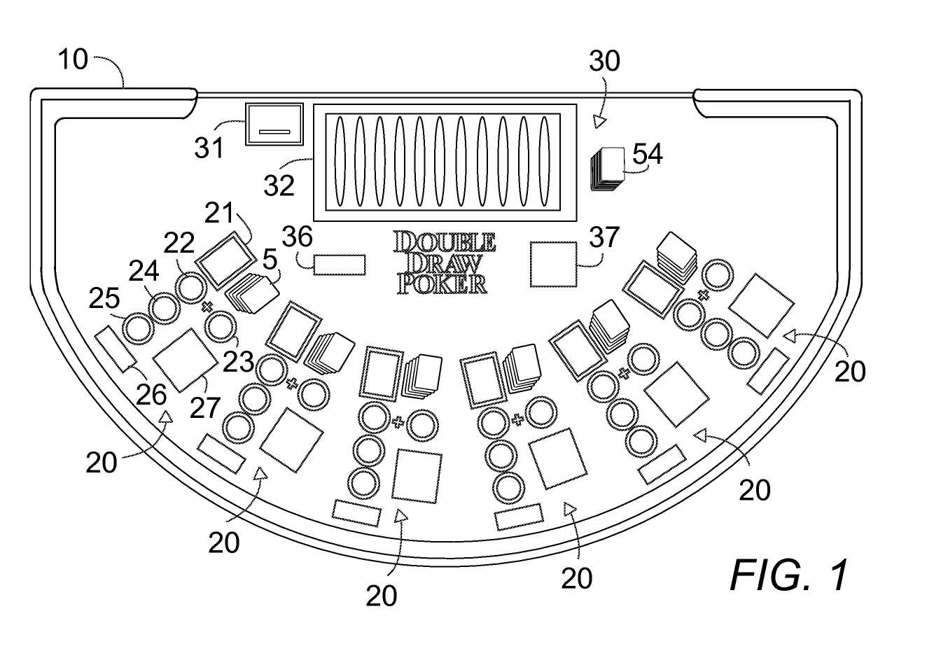

In FIGS. 1-8, a method for a double draw poker casino card game for a player receiving five dealt cards and having a first optional draw; discarding and drawing up to three draw cards, and having a second optional draw; discarding and drawing up to one draw card; producing a final double draw five card poker hand receiving a payout according to a first payout table 26/36 for an ante and draw bets and a payout according to a second payout table 27/37 for a bonus bet.

In FIGS. 1-5, the method of playing a double draw poker casino card game comprises:

a) a first step of providing a standard 52-card deck of playing cards for playing a standard draw poker casino card game and further providing two joker cards shuffled together with the standard 52 card deck to make a 54-card deck 54 as shown in FIG. 1, each of the two joker cards valued as an ace or as a fill-in card for a straight, or as a fill-in card for a flush;

b) a second step of placing an ante bet in a first bet location 22 in front of each player in a player layout 20;

c) a third step of placing a mandatory bonus bet in a second bet location 23 in front of each player;

d) a fourth step of dealing five cards 5 face down to each player;

e) a fifth step of the player viewing the player's own five dealt cards;

f) a sixth step of exercising an option to fold the player's own five dealt cards and forfeiting the player's ante bet and bonus bet, thereby ending the folding player's game for the hand; or an alternate sixth step of exercising an alternate option of placing a first draw bet to discard and draw up to three cards in a third bet location 24 in front of the player;

g) a seventh step of discarding onto a discard location 21 in front of the player and drawing from the deck from zero to three cards thereby holding a five card hand;

h) an eighth step of exercising an option to fold the player's own held five card hand and forfeiting the player's ante bet and bonus bet and first draw bet, thereby ending the folding player's game for the hand; or an alternate eighth step of exercising an alternate option of placing a second draw bet to discard and draw up to one card in a fourth bet location 25 in front of the player;

i) a ninth step of discarding onto a discard location 21 in front of the player and drawing from the deck from zero to one card thereby holding a final five card hand;

j) a tenth step of paying out the final double draw five card poker hand for each player according to a first payout table 26/36 for the ante and draw bets and according to a second payout table 27/37 for the bonus bet.

In the third step, placing a mandatory bonus bet preferably comprises placing a bonus bet equal to the ante bet.

In the alternate sixth step, exercising an alternate option of placing a first draw bet preferably comprises placing a first draw bet equal to the ante bet. In the alternate eighth step, exercising an alternate option of placing a second draw bet preferably comprises placing a second draw bet equal to the ante bet.

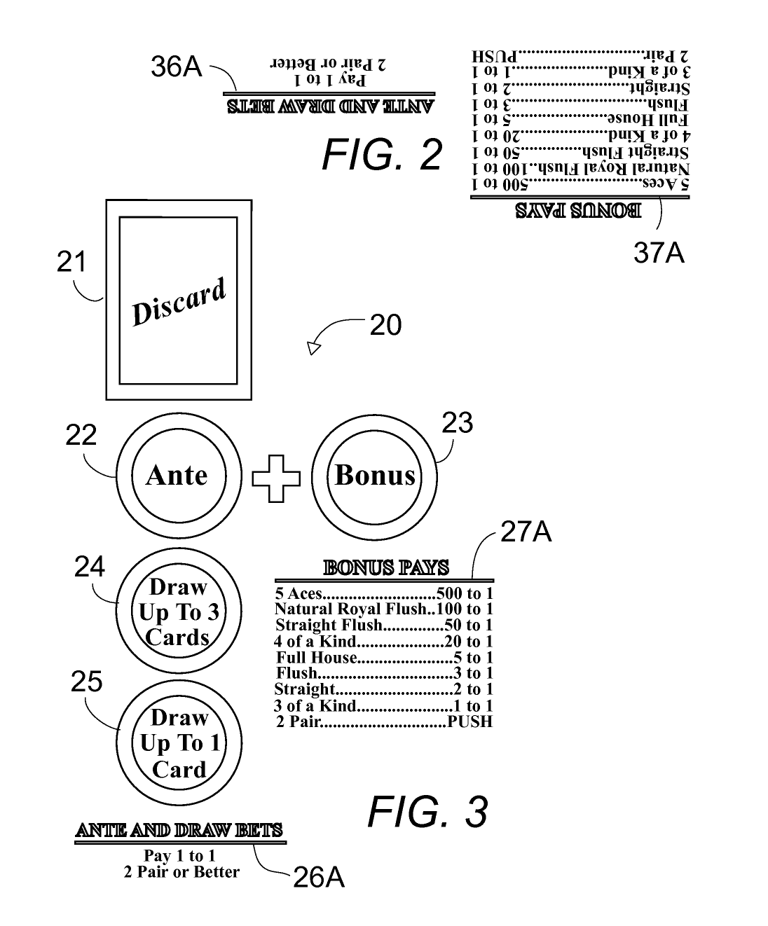

In FIGS. 2-3, the tenth step comprises paying out the final five card hand for each player according to a first payout table 26A/36A of paying out 1 to 1 for the ante bet and each draw bet for two pair or better and a second payout table 27A/37A comprising paying out the bonus bet: 500 to 1 for five aces, 100 to 1 for a natural royal flush, 50 to 1 for a straight flush, 20 to 1 for four of a kind, 5 to 1 for a full house, 3 to 1 for a flush, 2 to 1 for a straight, 1 to 1 for three of a kind, and push for two pair.

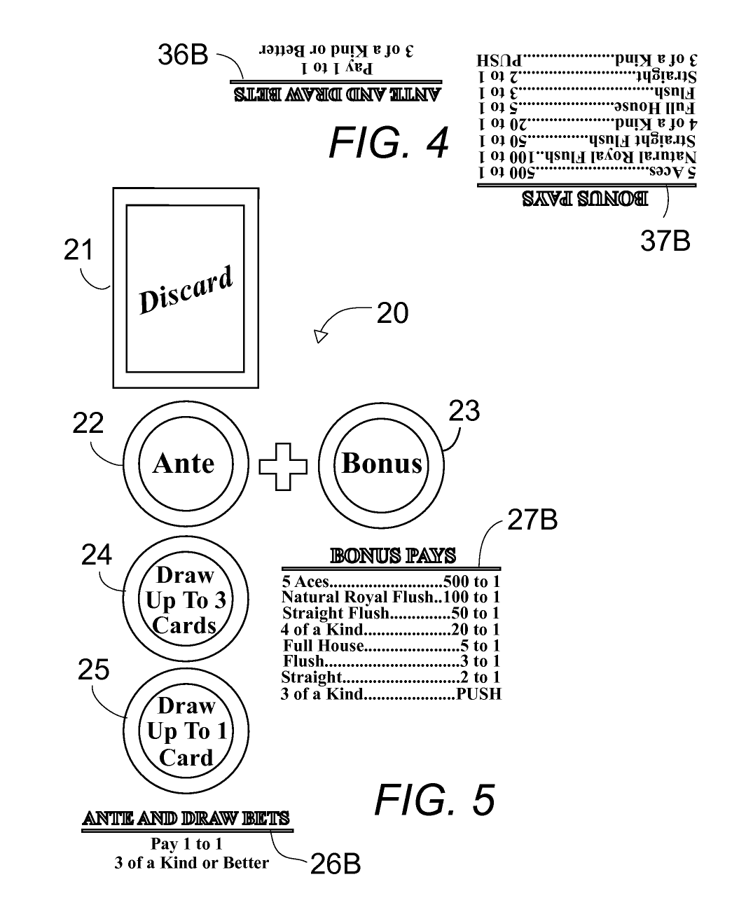

In FIGS. 4-5, the tenth step comprises paying out the final five card hand for each player according to a first payout table 26B/36B of paying out 1 to 1 for the ante bet and each draw bet for two pair or better and a second payout table 27B/37B for a bonus bet comprising paying out: 500 to 1 for five aces, 100 to 1 for a natural royal flush, 50 to 1 for a straight flush, 20 to 1 for four of a kind, 5 to 1 for a full house, 3 to 1 for a flush, 2 to 1 for a straight, push for three of a kind, and push for two pair.

In FIG. 1-5, the method comprises the step of providing a casino gaming table 10 for playing the double draw poker casino card game, each player carrying out the steps of the double draw poker casino card game by sitting at a casino gaming table with other players each in front of a player layout 20 and a dealer in front of a dealer layout 30, each player carrying out the steps of the method of the double draw poker casino card game by physically playing with five cards 5, dealt by the dealer from the deck of 54 cards 54 which includes two jokers, and physically placing bets on designated ante location 22, bonus location 23, and draw locations 24 and 25 in a double draw poker casino card game player layout 20, shown in detail in FIGS. 3 and 5, in front of each player. Bets and payouts may be made using poker chips or other tokens of monetary value or actual money.

In FIGS. 1-8, the method may alternately comprise the step of providing a simulation device for playing the double draw poker casino card game, a player carrying out the steps of the double draw poker casino card game using the simulation device, each player carrying out the steps of the double draw poker casino card game by manipulating the simulation device by placing simulation bets on designated ante location 22, bonus location 23, and draw locations 24 and 25 in a double draw poker casino card game player layout on the simulation device having similar player layouts 20 to the casino table 10 of FIG. 1.

In FIGS. 1-5, the method may alternately comprise the step of providing a mechanical simulation device, such as a board game board similar to the casino table 10 for playing the double draw poker casino card game. The board game comprises an additional step of selecting a player/dealer to sit in front of the dealer layout 30 to deal the cards and make the payouts. If not, the players may alternate being the player/dealer. The method of playing the double draw casino poker game on the mechanical simulation device comprises each player carrying out the steps of the double draw poker casino card game using the mechanical simulation device by physically playing with cards 5 dealt by a player dealer from the 54 card deck 54 and physically placing bets on designated ante location 22, bonus location 23, and draw locations 24 and 25 on a double draw poker casino card game player layout 20 in front of each player on the mechanical simulation device. Similar to the method played on an actual casino gaming table, bets and payouts may be made using poker chips or other tokens of monetary value or actual money in the method using a game board.

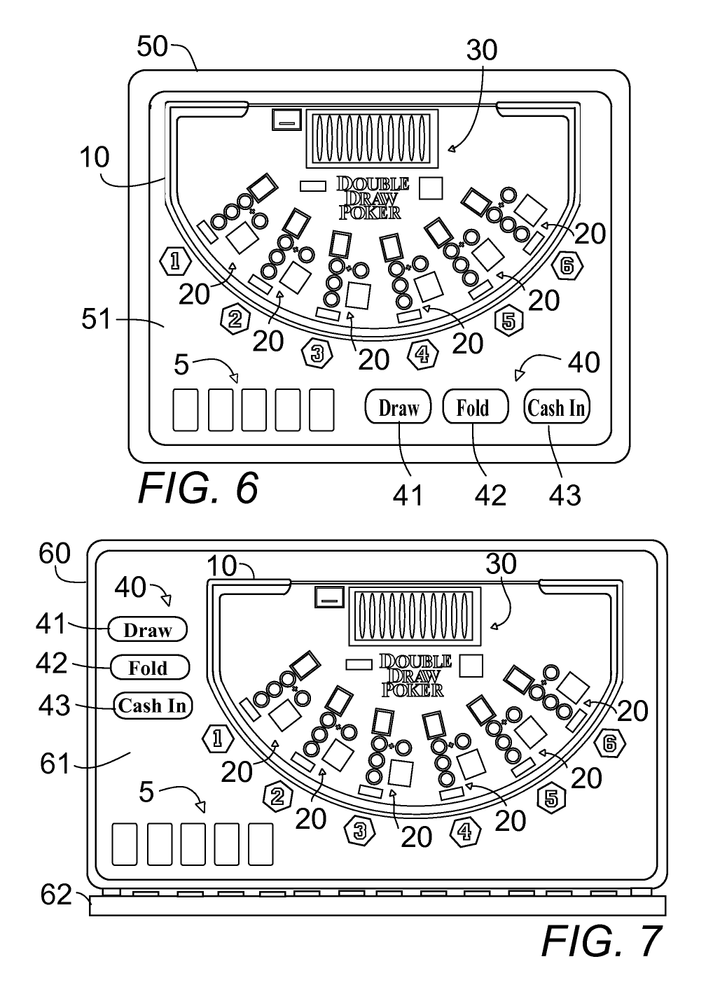

In FIGS. 6-8, the method comprises the step of providing an electronic simulation device 50, 60, and 70 for playing the double draw poker casino card game. The electronic simulation device comprising a screen 51, 61, and 71 showing a virtual representation of five cards 5 dealt to a player and a virtual representation of at least one double draw poker casino card game player layout 20. And further comprising means for a player to interact with the electronic simulation device 50, 60, and 70, each player carrying out the steps of the double draw poker casino card game using the electronic simulation device 50, 60, and 70 by inputting commands on the betting locations 22-25, on the hand of cards 5, and on additional inputting locations 40, including a draw location 41, a fold location 42, and a cash in location 43. Virtual bets are input to the designated ante location 22, bonus location 23, and draw locations 24 and 25 in the virtual double draw poker casino card game player layout on the screen 51, 61 and 71. After inputting a command for a bet in a first draw location 24, a player inputs commands to indicate which 0-3 virtual cards of the five cards 5 are to be discarded and replaced by virtual draw cards by inputting commands to touch any cards to be discarded from the five card hand 5 and then a command to contact the discard location 41 and then contact the draw location 41. Alternately folding the hand by inputting a command to contact a fold command location 42. After receiving the draw cards to replace the discard cards, inputting a command for a bet in a second draw location 25, a player inputs commands to indicate which 0-1 virtual cards of the hand of five cards 5 are to be discarded and replaced by a virtual draw card by optionally inputting a command to touch the card to be discarded from the five card hand 5 and then a command to contact the discard location 41 and then a command to contact the draw location 41. Alternately folding the hand by inputting a command to contact a fold command location 42. After all optional draws have been made and the final five-card hand of cards 5 is complete, cashing in by inputting a command to contact a cash in location 43.

In FIG. 6, the method of the present invention comprises the step of providing an electronic device 50, which may be a television or other entertainment or communication device, gaming device, a computer device, or other electronic simulation device having a viewing screen 51 showing the entire simulation of the double draw poker casino card game with the dealer location 30 and the player locations 20 each indicated by a player number 1-6 inside of a hexagon in front of a player location 20 for inputting a command to contact the desired player location hexagon for each player, as well as having the additional inputting locations 40. The method of play is carried out according to the method indicated above for an electronic simulation device. The steps involving inputting commands are accomplished by using controls for inputting commands found on gaming devices, computer devices, television and other entertainment and communication devices, or other electronic simulation device controls.

In FIG. 7, the method of the present invention comprises the step of providing a computer device 60, which may be a laptop or desktop or other computer device having a keyboard 62, and having a viewing screen 61 showing the entire simulation of the double draw poker casino card game with the dealer location 30 and the player locations 20 each indicated by a player number 1-6 inside of a hexagon in front of a player location 20 for inputting a command to contact the desired player location hexagon for each player, as well as having the additional inputting locations 40. The method of play is carried out according to the method indicated above for an electronic simulation device. The steps involving inputting commands are accomplished by using keyboard controls or a mouse or other computer input controls for inputting commands to carry out the steps of the method.

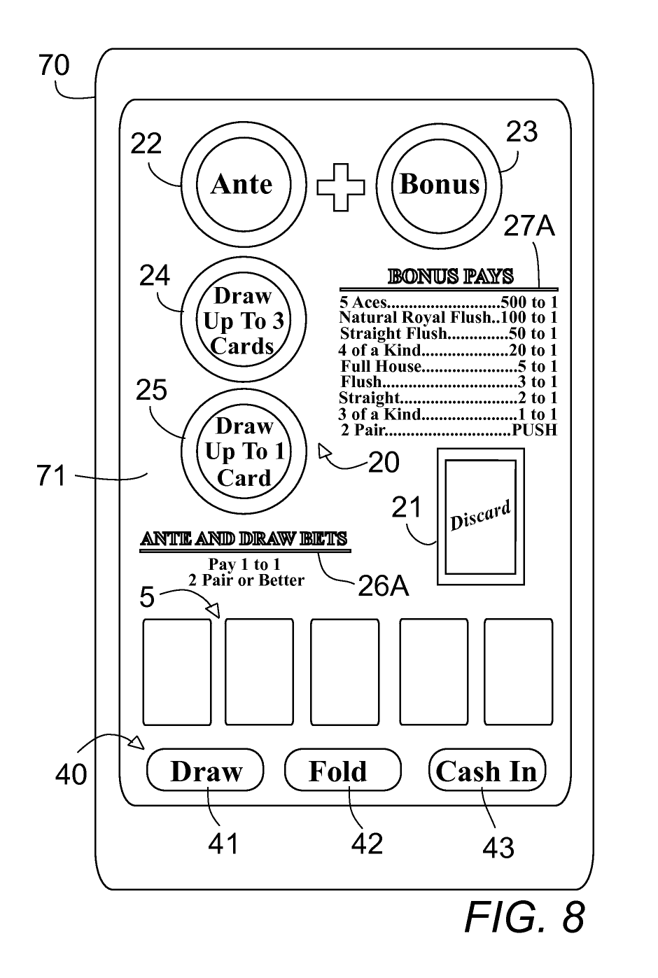

In FIG. 8, the method of the present invention comprises the step of providing a handheld electronic simulation device 70 for playing the double draw poker casino card game, the handheld electronic simulation device comprising a touch screen 71 as a means for interacting with the handheld electronic simulation device 70, a player touching the screen 71 to play the game using the method of the present invention wherein all of the inputting as indicated above in accomplished by touching the screen 71 in each of the desired locations. The handheld device 70 may be a smart phone, a handheld gaming device, or other communication or entertainment devices. The display screen 71 indicates a virtual display of the player location 20, as well as having the additional inputting locations 40 and the method of carrying out the method of the game is accomplished by inputting commands by touching the screen according to the method indicated above for electronic simulation devices.

The step of providing an electronic simulation device may comprise providing an electronic simulation device having a connection to a remote network for playing the double draw poker casino card game, wherein a player uses an the electronic simulation device having a connection to a remote network to play the game using the method of the present invention.

The step of providing an electronic simulation device may comprise providing an electronic simulation device having a wired connection to a remote network for playing the double draw poker casino card game, wherein a player uses an the electronic simulation device having a wired connection to a remote network to play the game using the method of the present invention.

The step of providing an electronic simulation device may comprise providing an electronic simulation device having a wireless connection to a remote network for playing the double draw poker casino card game, wherein a player uses an the electronic simulation device having a wireless connection to a remote network to play the game using the method of the present invention.

The step of providing a communication electronic simulation device may comprise providing a communication electronic simulation device having a connection to a remote network for playing the double draw poker casino card game, wherein a player uses an the communication electronic simulation device having a connection to a remote network to play the game using the method of the present invention.

The method wherein a player uses an the electronic simulation device having a connection to a remote network for playing the double draw poker casino card game using the method of the present invention and the electronic simulation device comprises a device taken from the list of electronic simulation devices comprising a computer, a handheld device, a telephonic device, an entertainment device, a gaming device, and a television device.

In use, the present method comprises a first step of providing a standard 52-card deck of playing cards for playing a standard draw poker casino card game and providing two joker cards shuffled together with the standard 52 card deck. Each of the two joker cards being valued as an ace or as a fill-in card for a straight, or as a fill-in card for a flush. The method further comprises the steps of each player placing an ante and a bonus bet and receiving five dealt cards. The method then comprises steps of each player either folding or making a first optional draw card bet and discarding and drawing up to three draw cards. The method then comprises steps of each player either folding or making a second optional draw card bet and discarding and drawing up to one draw card producing a final double draw five card poker hand. The method comprises a final step of each player having a final double draw five card poker hand receiving a payout against a first payout table for the ante and draw bets and a second payout table for the bonus bet.

It is understood that the preceding description is given merely by way of illustration and not in limitation of the invention and that various modifications may be made thereto without departing from the spirit of the invention as claimed.

What is claimed is:

1. A method of playing a double draw poker casino card game, the method comprising:
a) a first step of providing a standard 52-card deck of playing cards for playing a standard draw poker casino card game and further providing two joker cards shuffled together with the standard 52 card deck, each of the two joker cards valued as an ace or as a fill-in card for a straight, or as a fill-in card for a flush;
b) a second step of placing an ante bet in a first location in front of each player;
c) a third step of placing a mandatory bonus bet in a second location in front of each player;
d) a fourth step of dealing five cards face down to each player;
e) a fifth step of the player viewing the player's own five dealt cards;
f) a sixth step of exercising an option to fold the player's own five dealt cards and forfeiting the player's ante bet and bonus bet, thereby ending the folding player's game for the hand; or an alternate sixth step of exercising an alternate option of placing a first draw bet to discard and draw up to three cards in a third location in front of the player;
g) a seventh step of discarding and drawing from zero to three cards thereby holding a five card hand;
h) an eighth step of exercising an option to fold the player's own held five card hand and forfeiting the player's ante bet and bonus bet and first draw bet, thereby ending the folding player's game for the hand; or an alternate eighth step of exercising an alternate option of placing a second draw bet to discard and draw up to one card in a fourth location in front of the player;
i) a ninth step of discarding and drawing from zero to one card thereby holding a final five card hand;
j) a tenth step of paying out the final double draw five card poker hand for each player according to a first payout table for the ante and draw bets and according to a second payout table for the bonus bet;
thereby providing a method for a double draw poker casino card game for a player receiving five dealt cards and having a first optional draw discarding and drawing up to three draw cards and having a second optional draw discarding and drawing up to one draw card producing a final double draw five card poker hand receiving a payout according to a first payout table for the ante and draw bets and a payout according to a second payout table for the bonus bet.

2. The method of claim 1 wherein the third step of placing a mandatory bonus bet comprises placing a bonus bet equal to the ante bet.

3. The method of claim 1 wherein the alternate sixth step of exercising an alternate option of placing a first draw bet comprises placing a first draw bet equal to the ante bet.

4. The method of claim 1 wherein the alternate eighth step of exercising an alternate option of placing a second draw bet comprises placing a second draw bet equal to the ante bet.

5. The method of claim 1 wherein the tenth step comprises paying out the final five card hand for each player according to a first payout table of paying out 1 to 1 for the ante bet and each draw bet for two pair or better and a second payout table comprising paying out the bonus bet: 500 to 1 for five aces, 100 to 1 for a natural royal flush, 50 to 1 for a straight flush, 20 to 1 for four of a kind, 5 to 1 for a full house, 3 to 1 for a flush, 2 to 1 for a straight, 1 to 1 for three of a kind, and push for two pair.

6. The method of claim 1 wherein the tenth step comprises paying out the final five card hand for each player according to a first payout table of paying out 1 to 1 for the ante bet and each draw bet for two pair or better and a payout table comprising paying out: 500 to 1 for five aces, 100 to 1 for a natural royal flush, 50 to 1 for a straight flush, 20 to 1 for four of a kind, 5 to 1 for a full house, 3 to 1 for a flush, 2 to 1 for a straight, push for three of a kind, and push for two pair.

7. The method of claim 1 comprising the step of providing a casino gaming table for playing the double draw poker casino card game, each player carrying out the steps of the double draw poker casino card game by sitting at a casino gaming table with other players and a dealer, each player carrying out the steps of the double draw poker casino card game by physically playing with cards dealt by the dealer and physically placing bets on designated ante, bonus, and draw locations in a double draw poker casino card game player layout on the gaming table in front of each player.

8. The method of claim 1 comprising the step of providing a simulation device for playing the double draw poker casino card game, a player carrying out the steps of the double draw poker casino card game using the simulation device, each player carrying out the steps of the double draw poker casino card game by manipulating the simulation device by placing simulation bets on designated ante, bonus, and draw locations in a double draw poker casino card game player layout on the simulation device.

9. The method of claim 8 comprising the step of providing a mechanical simulation device for playing the double draw poker casino card game, each player carrying out the steps of the double draw poker casino card game using the mechanical simulation device by physically playing with cards dealt by a player dealer and physically placing bets on designated ante, bonus, and draw locations on a double draw poker casino card game player layout in front of each player on the mechanical simulation device.

10. The method of claim 8 comprising the step of providing an electronic simulation device for playing the double draw poker casino card game, the electronic simulation device comprising a screen showing a virtual representation of five cards dealt to a player and a virtual representation of at least one double draw poker casino card game player layout and further comprising means for a player to interact with the electronic simulation device, each player carrying out the steps of the double draw poker casino card game using the electronic simulation device by inputting commands indicating virtual bets on designated ante, bonus, and draw locations in the virtual double draw poker casino card game player layout on the screen and inputting commands indicating which virtual cards for discarding and replacing by virtual draw cards by activating a draw command location after designating the virtual cards for discarding, and alternately indicating folding on a fold command location or cashing in on a cash in button.

11. The method of claim 10 comprising the step of providing a handheld electronic simulation device for playing the double draw poker casino card game, the handheld electronic simulation device comprising a touch screen means for interacting with the handheld electronic simulation device, a player touching the screen to play the game using the method of the present invention.

12. The method of claim 8 comprising the step of providing an electronic simulation device having a connection to a remote network for playing the double draw poker casino card game, wherein a player uses an the electronic simulation device having a connection to a remote network to play the game using the method of the present invention.

13. The method of claim 12 comprising the step of providing an electronic simulation device having a wired connection to a remote network for playing the double draw poker casino card game, wherein a player uses an the electronic simulation device having a wired connection to a remote network to play the game using the method of the present invention.

14. The method of claim 12 comprising the step of providing an electronic simulation device having a wireless connection to a remote network for playing the double draw poker casino card game, wherein a player uses an the electronic simulation device having a wireless connection to a remote network to play the game using the method of the present invention.

15. The method of claim 12 comprising the step of providing a communication electronic simulation device having a connection to a remote network for playing the double draw poker casino card game, wherein a player uses an the communication electronic simulation device having a connection to a remote network to play the game using the method of the present invention.

16. The method of claim 12 wherein a player uses an the electronic simulation device having a connection to a remote network for playing the double draw poker casino card game using the method of the present invention and the electronic simulation device comprises a device taken from the list of electronic simulation devices comprising a computer, a handheld device, a telephonic device, an entertainment device, a gaming device, and a television device.
